(19) United States
(12) Patent Application Publication
(10) Pub. No.: US 2005/0233284 A1
(43) Pub. Date: Oct. 20, 2005

(54) Optical sight system for use with weapon simulation system

(76) Inventors: Pando Traykov, Suwanee, GA (US); Zhilie Li, Duluth, GA (US); Yang Shen, Alpharetta, GA (US); Wen Li, Alpharetta, GA (US); Jay Luo, Duluth, GA (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 10/974,543

(22) Filed: Oct. 27, 2004

Related U.S. Application Data
(60) Provisional application No. 60/514,815, filed on Oct. 27, 2003.

(51) Int. Cl. G09B 19/00

(52) U.S. Cl. 434/16

(57) ABSTRACT

An optical sight system is used in conjunction with such a weapon simulation system to immerse a user in the interactive simulation by employing an actual weapon sight with a simulated weapon, such that the view through the weapon sight is a clear view of an image on a primary image display. The system includes a secondary image display electrically connected to an image generator to receive the target corresponding to a magnified version of the scenario displayed on the primary image display. To view the image on the secondary image display with the weapon sight, the optical sight system includes an optical lens to correct the long focal distance of the scope and enable it to focus on the secondary image display. Through the use of a laser on the simulated weapon, the system is able to generate the desired magnified view on the secondary image display. Using a system of interpolation and extrapolation, the optical sight system is able to further create a clear magnified view of the primary image display. The system further provides a method for correcting the angle displayed on the secondary image display to compensate for rotation of the weapon simulator as handled by the user.

### CROSS REFERENCE TO RELATED APPLICATIONS

This application claims the benefit of U.S. Provisional Patent Application No. 60/514,815, filed Oct. 27, 2003, which is herein incorporated by reference in its entirety.

### BACKGROUND OF THE INVENTION

1. Field of the Invention

The present invention relates to simulated weapons and, more particularly, to an optical sight system including a simulated weapon which allows the incorporation and use of an actual weapon sight combined with a micro display in a simulated weapon environment.

2Description of the Prior Art

Firearms training simulators are used to train police and military personnel the proper use and handling of weapons without having to use real firearms and ammunition. The firearms training simulator is designed for indoor training in a safe environment. An effective firearms simulator duplicates the actual environment as much as possible including the use of simulated weapons that “look and feel” like the actual weapons. To improve the “look and feel” of the simulated weapon, the user will be able to employ a firearm optical sight on the simulated weapon (either unmodified or adapted for use on the simulator). The primary objective is to immerse the student in a training scenario so that his/her responses will be the same in the training scenario as in real life. If this is achieved, the instructor can effectively train the student on the correct responses, actions and behaviors.

To facilitate this, the student should be immersed in the training environment as much as possible, and the instructor should have as much visibility as possible of the way a student handles the weapon, including the student's aiming techniques. One desired improvement of conventional firearms simulator systems is to replicate real weapons that employ either actual firearm optical sights with great magnification or electro-optical devices such as night vision devices or thermal sights. With such weapon simulation systems, there have been various ways to incorporate the use of both an actual optical sight and a simulated optical sight with a simulated weapon to provide the desired scenario.

One option is to build a completely new weapon sight or weapon scope simulator device without using an actual weapon sight with the simulated weapon. Such a device would provide for the simulation of a weapon sight rather than using an actual weapon sight, and would include a display, optical system, reticule, and elevation adjustment mechanicals. Consequently, this option has a lack of flexibility for the user. For example, to simulate different scope, different simulators need to be built, and the student or user could not select the desired scope if that scope simulator has not been built.

A second option is to use an actual optical sight in conjunction with the simulated weapon, such that the user would examine the generated display image of the scenario with the actual firearm optical sight. Although optical sights with magnification greater than about two-times could be used with such a weapons simulation system, the image would be negatively altered due to pixelization. That is, when the digital image is enlarged through the magnification of the scope, the user will see the various pixels that compose the digital picture. Therefore, the picture will appear very pixilated to the point that the image is not realistic to the user, and therefore not usable for realistic training as is necessary for effective training. This approach also does not allow for mixed use of iron or optical sights together with electro-optical sights such as night vision and thermal sights.

### BRIEF SUMMARY OF THE INVENTION

The present invention is an optical sight system that is used with weapon simulation systems so as to improve the realism of the weapon simulation system for the user or student. In particular, the present optical sight system is used with an actual weapon scope or weapon sight in a weapon simulation system so that the user is able to view a correct version of the image broadcast on a primary image display with the scope and maintain the reality of the simulation. More specifically, the weapon simulation system includes primary image display and a simulated weapon that are both in electrical communication with a central processing unit having an image generator to produce the desired target or interactive scenario that is sent to the primary image display to immerse the student or user in the desired situation.

The optical sight system of the present invention is used in conjunction with such a weapon simulation system to further immerse the student or user in the interactive simulation. Specifically, the present invention employs an actual weapon sight or a weapon scope with the simulated weapon, and includes a secondary image display or display panel that is electrically connected to an image generator to receive a target or interactive scenario with an image corresponding to a magnified version of the scenario displayed on the primary image display. To view the image on the secondary image display with the weapon sight, the optical sight system additionally includes a lens or multiple lenses to correct for the long focal distance of the scope and enable it to focus on the micro display positioned only inches away. Through the use of a laser on the simulated weapon, the system is able to generate the desired magnified view on the secondary image display. Furthermore, using a system of interpolation and extrapolation, the optical sight system is able to create a clear magnified view of the primary image display. Using an angle sensor, the optical sight system further provides a method for correcting the angle displayed on the secondary image display to compensate for rotation of the weapon simulator as handled by the user.

### BRIEF DESCRIPTION OF THE DRAWINGS

An apparatus embodying the features of the present invention is depicted in the accompanying drawings, which form a portion of this disclosure, wherein:

FIG. 1 is a block diagram of a first embodiment of the an optical sight system of the present invention incorporated in a weapon simulation system;

FIG. 2a is an illustration of the connection of weapon sight with a secondary image display via a housing;

FIG. 2b is a diagram illustrating the optical lens positioned between the weapon sight and the secondary image display lens;

FIG. 3 is a block diagram of a second embodiment of the optical sight system of the present invention incorporated in the weapon simulation system;

FIG. 4 is a photograph of a scenario displayed on a primary image display of the weapon simulation system;

FIG. 5 is a photograph of a magnified scenario displayed on a secondary image display of the optical sight system;

FIG. 6 is an illustration of the image generated on the primary image display and the corresponding magnified image generated on the secondary image display;

FIG. 7 is an illustration of the image generated on the primary image display and the corresponding magnified image generated on a rotated secondary image display, the image on the secondary image display not being compensated for rotation of the simulated weapon;

FIG. 8 is an illustration of the image generated on the primary image display and the corresponding magnified image generated on a rotated secondary image display, the image on the secondary image display being compensated for rotation of the simulated weapon;

FIG. 9 is a flow chart of the process for generating an image on the secondary image display compensating for rotation of the simulated weapon; and

FIG. 10 is a photograph of a scenario displayed in the secondary image display after compensation of rotation of the simulated weapon.

### DETAILED DESCRIPTION OF THE INVENTION

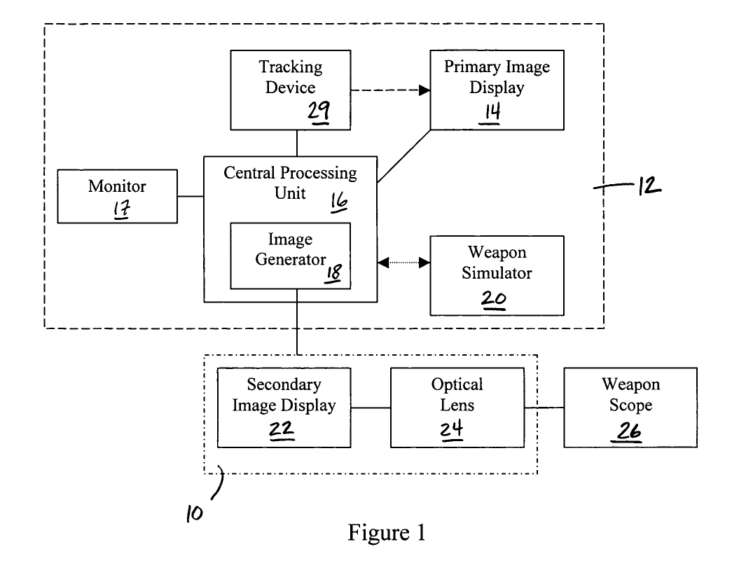

Looking to FIG. 1, the present invention of an optical sight system 10 is illustrated in use with a weapon simulation system 12. The optical sight system 10 is used to improve the realism of the weapon simulation system 12 for a student or other user. In particular, the optical sight system 10 is used with a weapon simulation system 12 that conventionally includes a primary or first image display 14 that is electrically connected with a central processing unit 16 (“CPU”) or a related means for generating and transmitting a target or interactive scenario on the primary image display 14. The first image display 14 may include any type of display, such as a projected image or an image display system. The weapon simulation system 12 further includes a simulated weapon 20 that has a conventional weapon housing (not illustrated), such as a rifle, a shotgun, handgun, taser, or other related weapon or device used to train students in the use of that particular device. The simulated weapon 20 is further in electrical communication with the CPU 16. As referred to herein, electrical communication can be through a direct physical connection or also through a radio frequency (RF) wireless connection using wireless technology such as “Bluetooth”, WiFi, or other similar technologies. The CPU 16 includes an image generator 18 that is used to generate the desired target or interactive scenario that is sent to the primary image display 14 so as to immerse the student or user in the desired situation.

Continuing to view FIG. 1, the optical sight system 10 of the present invention is used in conjunction with the weapon simulation system 12 to further immerse the student or user in the interactive simulation. Specifically, the optical sight system 10 employs a weapon sight or a weapon scope 26 with the simulated weapon 20. In particular, the optical sight system 10 includes a secondary image display or display panel 22 that is electrically connected to the CPU 16 to receive the target or interactive scenario produced by the image generator 18 that corresponds with the primary image display 14. The optical sight system 10 additionally includes an optical lens 24 to correct the user's line of sight, as discussed herein.

The optical sight system 10 is designed to be capable of attachment to a simulated weapon 26 with a weapon sight 26 that is used on actual weapons, not just simulated weapons 20. As a result, the student or user may use his or her own preexisting weapon sight 26 with the optical sight system 10 to perform the training tasks, which maximizes the reality of the training scenario for the student. That is, the student can be trained to operate his or her own actual weapon sight 26 on the simulated weapon 20.

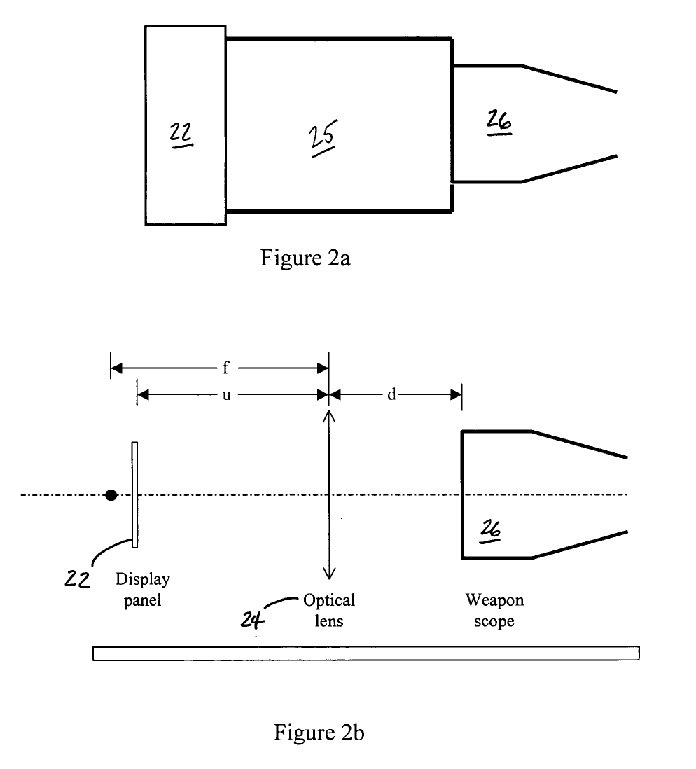

The present invention of the optical sight system 10 is designed to be used with the actual weapon sight 26. To properly work with the actual weapon sight 26, the optical sight system 10 includes a secondary image display 22 and an optical lens 24. Referring to FIG. 2b, the optical lens 24, which can take the form of a convex lens, is placed between the secondary image display panel 22 and the weapon sight 26 to enable the weapon sight 26 to focus on the image at the secondary image display 22. Since the weapon sight 26 is designed to view objects that are far away (practically at infinity), the function of the optical lens 24 is to project the image on the secondary image display panel 22 at infinity so that it can be seen through the weapon sight 26. In the embodiment illustrated in FIG. 2a, the optical lens 24 is secured in a lens housing 25, which may be threaded to provide a tight engagement with both the weapon sight 26 and the secondary image display 22.

It should further be noted that the secondary image display panel 22 may be any type of microdisplay that may be mounted either to the weapon housing 20 or the weapon sight 26. Although the size of the secondary display panel 22 will vary in view of the size of the weapon housing 20, in one useful embodiment, the display area of the microdisplay 22 as viewed by the user has dimensions that are less than 17 millimeters by less than 13 millimeters.

The optical sight system 10 is attached to the front of the real weapon sight 26 or to the simulated weapon 20. The electronic image generated on the secondary image display 22 is seen through the weapon sight 26 so as to utilize the real weapon sight 26. The reticule and the elevation adjustment mechanisms of the weapon sight 26, as originally built in the weapon sight 26, are able to be used with the optical sight system 10 as in an actual use of the weapon sight 26. The student can use his own weapon sight 26 and attach the optical sight system 10 to the frame of the simulated weapon 20 prior to starting the training.

In operation, the secondary image display panel 22 in the optical sight system 10 displays the portion of the primary image that is in the center of the student's aim with the simulated weapon 20. Although various tracking methods could be used utilizing inertial, mechanical, magnetic or optical sensors, in the embodiment presently described, the center of the student's aim is determined through the use of a laser. More specifically, in order to detect the aiming point of the simulated weapon 20 and transmit the corresponding image to the secondary image display 22 of the optical sight system 10, a tracking position device 29 (such as a laser tracking camera) is used to monitor the primary image display 14 and locate the laser spot position, which is projected from simulated weapon 20 held by the student. This tracking position device 29 transmits the detected laser spot position to the software application run by CPU 16 as a reference point to calculate the aiming point of the simulated weapon 20. Based on the aiming point, the secondary image display 22 can display the correct zoom image of the scene produced by the image generator 18. The application generates the zoom image corresponding to the aiming point and displays it on the secondary image display 22. The image in the secondary image display 22 will give the student the same look and feeling of a real weapon scope in an actual setting. Through the use of a laser beam combined with a laser detector 29 for tracking the position of the laser, and thus the user's aim, the optical sight system 10 can provide high accuracy and fast response time position information. The embodiment uses the information of the laser spot location detector 29 as the only resource for determining the aiming point and then generates the corresponding image in the secondary image display 22.

In an example of this system, a laser LED is installed in the barrel of simulated weapon 20. At the same time, the optical sight system 10 is installed with the simulated weapon 20. While the system is operating, a laser beam from the laser LED is projected to the primary image display 14 having the training scenario scene image as produced by the image generator 18. The laser spot location is changed following the location of the student's aim corresponding to the position of the simulated weapon 20. The laser spot location is real-time detected by a tracking position device 29 connected to the CPU 16 and processed to generate aiming point information of the simulated weapon 20; specifically the coordinates of the aiming point with respect to the primary image display 14. From the aiming point information, the software application of the CPU 16 can determine where the gunner is aiming on the scenario or scene image of the primary image display 14. The relative image is processed according to scope's field of view, magnification and the position of the weapon in the virtual world. The proper image is then displayed on optical sight system 10, which can be seen by the student through the weapon scope 26. The image on the primary image display 14 is exactly the same as what student would see in the real world without a scope.

The present invention provides a simulation system with a training range from several hundred meters to several thousand meters. When targets are at several thousands of meters, the resolution of most simulation screens, such as the primary image display 14 of the present invention, is too low to display the target so that the student can see it in detail. In the real world situation, the user employs the weapon scope 26 on the firearm to find and engage the target if the target is a great distance away. The fundamental problem is determining how to get the correct image reference point for the secondary display image 22; that is, the center point of image on the primary image display 14 being targeted. Therefore, the present invention uses laser spot detection to determine the center of the image generated on the secondary display.

Microsoft Windows 98 and newer operating systems provide support for multiple graphics displays. This functionality is helpful for engineers to implement and test the concept at a low cost. In the initial stage, the engineers use the second graphic card output as optical sight system 10 and, without a physical tracking position device 29, they use a mouse to simulate the movement of the aiming point. When the mouse is pointing at a scale 1:1 image, using a software timer to regularly collect the mouse position, then the programmer calculates the zoom image position and displays the zoom image to the second monitor 17. In the present invention, the mouse position is replaced by the laser position, and the second monitor 17 is replaced by the secondary image display 22.

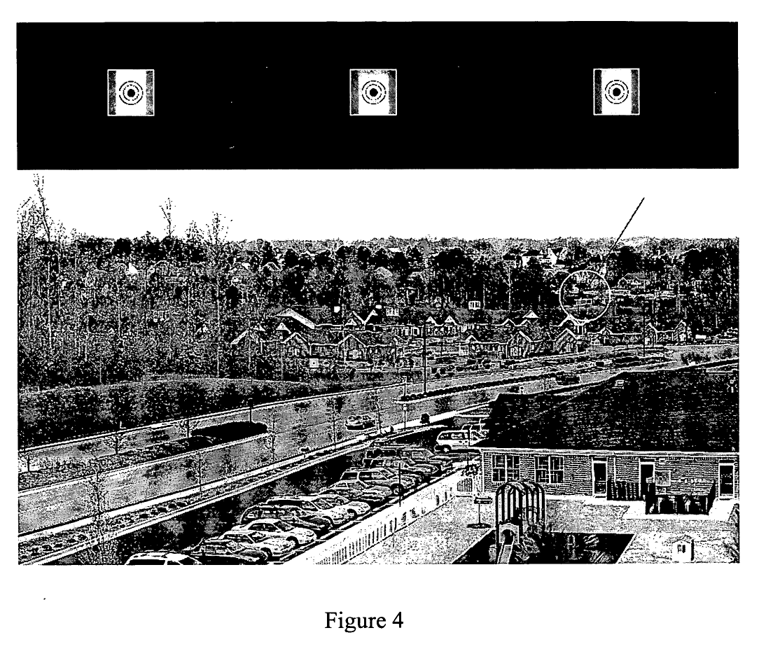

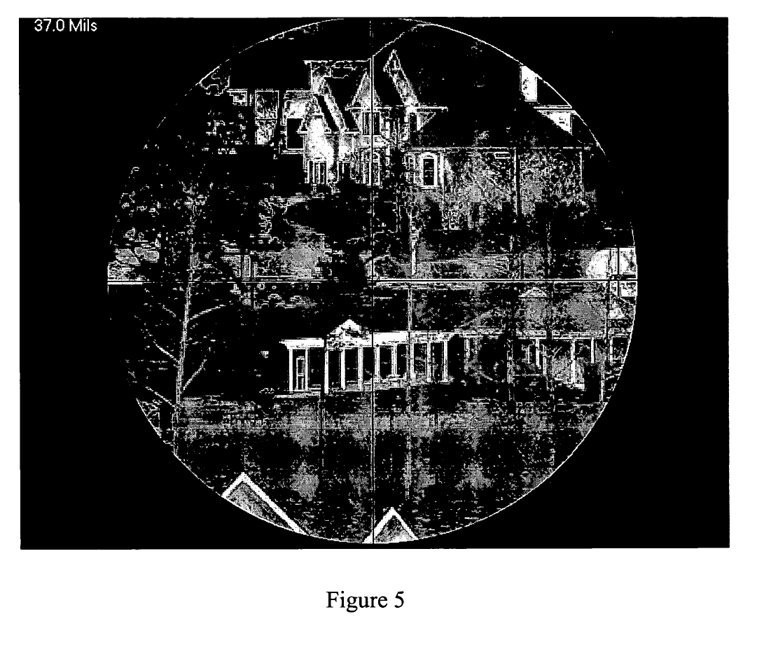

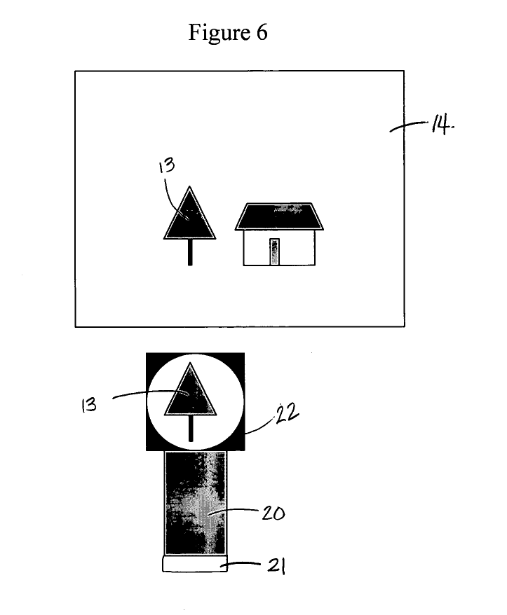

Looking to FIG. 4, a training scenario scene image as transmitted on the primary image display 14 is illustrated, which is to be compared with the magnified image transmitted on the secondary image display 22 illustrated in FIG. 5. FIG. 4 provides the training scenario scene image, with the magnified image of the secondary image display 22 clearly showing that the target is a car behind a tree; based on the magnification of the scope the trainee can estimate that the target is at distance of about 1500 meters. Due to low resolution and wide field of view of the primary image display 14 as well as the virtual distance between the projected target and the student, it is nearly impossible for the user to find and engage target just from the training scenario scene image on the primary image display 14. However, using the scope 26 with the optical sight system 10, with the current field of view 37 mils, about 2 degrees, the trainee can see the magnified image in FIG. 5 which is what the student would see in the real world when looking through the weapon scope 26. As noticed in the comparison of FIG. 5 and FIG. 6, the student will be able to see the target very clearly with the weapon sight 26.

Therefore, the student can see the precise image through the weapon sight 26 aimed at the primary image display 14, or the user can see the broad image by simply looking at the primary image display 14. That is, the student not only needs to view the image clearly, but he/she also needs to see the maximum of the image display panel area so that the he/she can fully utilize the resolution of the secondary image display 22. For example, if the optical lens 24 is not properly selected/designed, then the student will not see the full picture in the secondary image display 22. For example, if the magnification of the weapon sight 26 is too great, the student may only see a 400×400 area on a 1024×768 display panel 22, such that the student will not be able to view the complete display area of the secondary image display panel 22. Moreover, in this case, the resolution on the panel of the secondary image display 22 will be poor, and the student will see the grainy pixels from the panel of the secondary image display panel 22 because the magnification is too large. As a result, the quality of the image will be substantially lowered. On the other hand, if the magnification of the weapon sight 26 is too low, the student may see the edges of the secondary image display panel 22, and there is no room for the elevation adjustment.

One added benefit of using the optical sight systems 10 of the present invention is that the instructor can see the student's actual aim point by viewing the image generated for the student's electro-optical device on a separate monitor 17 connected to the CPU 16. This allows the instructor to see the same image that is displayed on the secondary image display 22.

In order to overcome some issues such as image pixelization when viewing a primary image display 14 with optical magnification devices, the secondary image display panel 22 may be used to display an image for that particular optical device. Since some users (snipers and others) are particularly sensitive to having modifications made to their weapon sight 26 and are hesitant in training with equipment other than their own, a small device attaching to the user's weapon sight 26 to allow the student to use all the adjustments of the weapon sight 26 is ideal for the firearms training simulation market. The image injected in the weapon sight 26 is specific to that optical device, and is provided based on a tracking algorithm used to determine the user's point of aim.

When a laser is used to track a moving target, the simulated weapon 20 will fire laser beams periodically. In order to reduce the load of the weapon simulation system 12 on the CPU 16, the period cannot be very short, particularly if the system is to track multiple targets on the primary image display 14. The rate of firing laser beams will be controlled to less than 15 times per second, ideally 10 times per second. But the rate for updating the image according to the coordinates of the laser spots must be at least 30 times per second. As a result, a tracking algorithm must be used for determining the image transmitted to the secondary display 22 during each frame.

The tracking algorithm used in the present invention is referred to as “intrapolation”, which is a combination of extrapolation and interpolation. Extrapolation is an estimation of the value based on extending a known sequence of values or facts beyond the area that is certainly known, whereas interpolation is an estimation of a value within two known values in a sequence of values. Using interpolation makes the movement smoother, but increases the delay of the transmitted picture. By contrast with interpolation, extrapolation takes shorter delay, but it causes excessive movement of the image transmitted. The excessive movement is created when the target stops suddenly or changes direction, which leads to change in the student's aimpoint, and the optical sight system 10 does not know until the next laser coordinates have been obtained by the optical sight system 10. During this interim time, the optical sight system 10 still updates the image according to the prior coordinates. This causes the target to “oscillate” several times before it stops. In the present design, interpolation and extrapolation are both used to get smooth tracking, shorter delay and less overshoot movement.

The tracking algorithm used in the present invention follows the process of “intrapolation” for generating the desired display. For purposes of the present invention, intrapolation is a combination of interpolation and extrapolation. The formula of intrapolation for the present invention is:

$$\begin{matrix}{x}_{c} = {x}_{n - 2} + \frac{{x}_{n - 1} - {x}_{n - 2}}{Δ} \cdot {t}_{u} & ( 1 ) \\ {y}_{c} = {y}_{n - 2} + \frac{{y}_{n - 1} - {y}_{n - 2}}{Δ} \cdot {t}_{u} & ( 2 ) \\ Δ = {t}_{n - 1} - {t}_{n - 2} & ( 3 ) \\ {t}_{u} = {t}_{c} - {t}_{sd} - {t}_{n - 2} & ( 4 )\end{matrix}$$

In the formula above:
x_{c}, y_{c} is the coordinate corresponding to the current time t_{c} that is to be intrapolated;
xₙ₋₁, yₙ₋₁ is the coordinate corresponding to the last updated time tₙ₋₁;
xₙ₋₂, yₙ₋₂ is the coordinate corresponding to the last updated time tₙ₋₂ before tₙ₋₁;
Δ is time difference between most recent updated time tₙ₋₁ and the updated time prior to the most recent updated time tₙ₋₂;
tᵤ is the update time;
t_{sd} is system delay time (system delay is obtained through experimentation with particular systems; in the embodiment illustrated in the present case it is 33 ms);
t_{c} is the time at which the program is to intrapolate; and
xₙ₋₁, xₙ₋₂, yₙ₋₁, yₙ₋₂, tₙ₋₁, tₙ₋₂ are from the hit detection packets.

Using these formulas, the change between the times to be intrapolated is determined. Because Δ is calculated from tₙ₋₁ and tₙ₋₂, the invention ignores the intrapolation of the first two trace lasers. If tᵤ≦Δ, the values for the coordinates of the location of the center of the secondary image are calculated using interpolation; otherwise, extrapolation is used.

The test system is a sniper rifle equipped with a through sight. The laser rate is 10 pulses per second. By using the tracking algorithm stated above, the tracking is smooth, fast and without much overshoot. When the rifle is at rest, such as being laid on the ground, the cross hair of the telescope does not move.

Furthermore, the noise in the image may be reduced by incorporating a Kalman filter. That is, when tracking a still target with the laser, the movement of the cross hair of the weapon sight 26 can be controlled within two screen pixels. Using laser to track the moving target has another problem in random noise. If the user requires high tracking accuracy, the noise cannot be ignored. To reduce the noise, the Kalman filter is used. A Kalman filter is used to estimate the state of a system from measurements that contain random errors.

In one embodiment of the invention, the optical sight system 10 is coupled with radio frequency (RF) technology and battery power (not illustrated) to provide a wireless version allowing unrestricted freedom of movement of the user.

The use of microdisplays 22 with image generators 18 makes this approach feasible for applications such as:
1.) A simulated weapon 20, such as a sniper rifle, fitted with a weapon sight 26. This simulated weapon 20 will allow the user to manipulate the adjustments of the weapon sight 26 for windage, elevation, focus, and eye-relief;
2.) A binocular simulator allowing the user to employ their particular model and manipulate the adjustment for the focus; and
3.) A night vision or thermal scope attaching to an optical sight 26. In this case, the attachment containing the microdisplay 22 could be shaped as the corresponding night vision or thermal sight and have additional sensed controls for image brightness, intensity, and polarity.

The purpose of the optical sight system 10 is to make the displayed image clearly seen through the weapon sight 26 without degrading the optical specification of the weapon sight 26. To achieve that, the image must be projected away from the weapon sight 26. The distance of the projection from the weapon sight 26 depends on the parallax-free distance of the weapon sight 26, or the distance at which there is no apparent displacement, or difference of position, of an object, as seen from two different stations, or points of view.

More specifically, if the parallax-free distance of a weapon sight 26 is 200 meters, then the image should be projected at 200 meters away from the weapon sight 26. Once the image is projected at 200 meters, the optical system 10 and the human eye can focus and produce a clear image on the human retina.

Referring to FIG. 2b, to project the image of the optical sight system 10 at 200 meters away, the simplest method is to use an optical lens 24 that is a single convex lens. To determine the distance of the focal point from the weapon sight 26, the relationship of the focal length of the optical lens 24, the distance between the secondary image display 22 and the optical lens 24, and the image plane distance from the optical lens 24 is described as follows:

$$\frac{1}{f} = \frac{1}{u} + \frac{1}{v}$$

where
“f” is the focal length of the optical lens 24 (mm);
“u” is the distance between the secondary image display 22 and the optical lens 24 (mm); and
“v” is the image plane distance from the optical lens 22, which is −200 meters.

The use of the optical sight system 10 has been verified through testing with a tactical scope, a single convex lens, and a microdisplay unit 22 mounted on a micro-optical rail 27 attached to a rifle. The effect of the invention on the parameters of the optical sight system 10 was determined to be as follows. With respect to the magnification, since the image displayed on the secondary image display 22 is controlled by an image generator 18, if the image displayed on secondary image display 22 is properly scaled, then the image seen by the student using the optical sight system 10 has the equivalent magnification to the image that would be seen through the weapon sight 26. The eye relief, or the distance that the weapon sight 26 can be held away from the user's eye and still present the full field of view, did not change for the weapon sight 26 when in use with the optical sight system 10. The exit pupil, or the size of the column of light that leaves the eyepiece of a weapon sight 26, may be affected if the diameter of the added optical lens 24 is smaller than the objective lens diameter of the weapon sight 26. In particular, the larger the exit pupil, the brighter the image. The field of view, which is the side-to-side measurement of the circular viewing field or subject area, does not change if the generated image is scaled down correctly by the image generator 18. Parallax error can be adjusted by adjusting the distance between the secondary display image panel 22 and the optical lens 24, defined as “u” in the equation above. Parallax error is the condition that occurs when the image of the target is not focused precisely on the reticle plane. Parallax is visible as an apparent movement between the reticle and the target when the shooter moves his head or, in extreme cases, as an out-of-focus image.

The portion of the displayed image that can be seen through the weapon sight 26 depends on the focal length of the optical lens 24 and the field-of-view of the weapon sight 26. The following equation explains the relationship between the limiting dimension W (width or height) of the secondary image display panel 22, the field of view of the weapon sight 26, and the focal length f of the optical lens 24:

$$W = \frac{FOV}{100} \times f ( mm )$$

where
“W” is the limiting dimension of the secondary image display panel 22;
“FOV” is the field of view of weapon sight 26, (in meters);
“100” is the distance that the field of view is measured (100 meters); and
“f” is the focal length of the convex lens 24 (in millimeters).

As a result, in order to minimize the pixelization of the image of the secondary image display panel 22 seen by the user through the weapon sight 26, the focal length of the optical lens 24 has to be selected so that the largest area of the display 22 is seen by the user. The remaining variables of the equation are fixed in view of the equipment used in the optical sight system 10.

Selection of the focal length of the optical lens 24 depends on the magnification of the weapon sight 26 and the size of the secondary image display panel 22. The magnification is the optical sight parameter that the user is most concerned with, and it is related to the FOV and other parameters of the optical sight. For the purpose of the present embodiment, the FOV used is the FOV published by the sight manufacturer (or it is determined experimentally if it is not known), and use the last formula to solve for the focal length of the lens given the limiting dimension (W) of the secondary image display 22 that is being used.

For example, for a display panel 22 having 12 mm×9 mm dimensions, a 4× scope needs a 120 mm focal length lens and the secondary image display panel 22 should be put 120 mm away from the optical lens 24. In comparison, a 12× scope needs a 400 mm focal length lens and the image panel should be put 400 mm away from the optical lens 24. This means that a housing of the optical sight system 10 should be at least 400 mm long and should be attached to the 12× weapon sight 26 so that the image can be seen clearly and the maximum display area can be seen through the scope 26. If a 120 mm lens is used with the 12× weapon sight 26, the image area seen through the weapon sight 26 is only 1/9 of the display area that the 4× weapon sight 26 can see.

For illustrative purposes, consider an equilateral triangle formed by the limiting dimension (W) of the secondary image display 22 and the focal point 400 mm away. If the secondary image display 22 is moved closer to the focal point, so that it is only 120 mm away, the portion of the secondary image display 22 that is between the legs of the equilateral triangle above would be only about ⅓ (actually 120/400 based on similar triangles). Since the FOV of a weapon scope 26 is generally conical, the area of the display that would be seen is essentially a circle. If the radius of the circle when the right focal length lens (400 mm) is selected is chosen to be R and the radius of the circle when the wrong lens (120 mm) is used is r, then the relationship between the two is approximately r=R/3. Since the area of a circle is equal to πR², then the area of the small circle would be approximately 1/9 of the area of the large circle.

The single convex lens structure requires different optical sight systems 10 for different weapon sights 26, because it uses different optical lenses and different distances between the optical lens 24 and the secondary image display panel 22. For example, if a user has two weapon sights 26, one being 4× and one being 12×, then the user will need two optical sight systems 10 for the weapon sights 26; one shorter optical sight systems 10 for the 4× scope and one longer optical sight system 10 (more than 400 mm long) for the 12× scope.

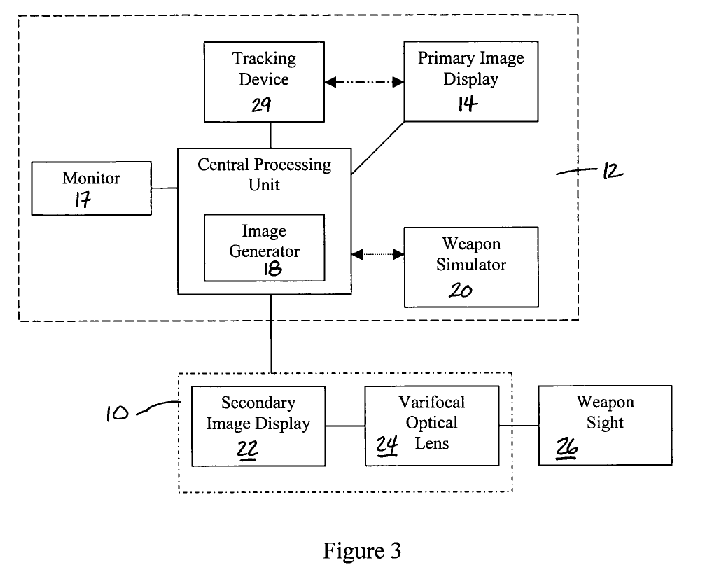

As a result of these limitations provided an optical lens 24 that is a single convex lens, another embodiment of the optical sight system 10 is provided as illustrated in FIG. 3. More specifically, the optical sight system 10 of this embodiment utilizes a varifocal length optical lens 30 rather than the single convex lens 24. By incorporating a varifocal length optical lens 30, the optical sight system 10 can be used with various weapon sights 26. A varifocal length optical lens 30 will provide a range of focal lengths for the system.

In the embodiment illustrated in FIG. 3, the optical sight system 10 is suitable for weapon sights 26 having varying magnifications. That is, this embodiment of the optical sight system 10 utilizes a varifocal length optical lens 30. The equivalent focal length of the varifocal length optical lens 30 can be adjusted from 100 mm to more than 440 mm, so it is suitable for the scopes from 4× to 12×. The length of the optical sight system 10 is fixed at about 200 mm. The focus and focal length can be adjusted to produce the clear image as well as the right size of the image seen through the weapon sight 26.

The optical sight system 10 of this embodiment increases the flexibility, reduces the production process and reduces the setup process for the different weapon sights 26. Furthermore, the optical sight system 10 provides the desired resolution of the image to the user through the weapon sight 26, such that the image retains clarity through the weapon sight 26, and the user is able to distinguish fine detail.

Referring to FIG. 6, it should be noted that the optical sight system 10 comprises a secondary image display 22 that is connected in a fixed manner with the weapon sight 26, and that the combination of the secondary image display 22 and the weapon scope 26 are affixed to the simulated weapon 20. An image is projected onto the primary image display 14 for purposes of firearms training, and when the simulated weapon 20 is aimed at the primary image display 14, the area around the aim point is enlarged and rendered to the secondary image display 22, as discussed above.

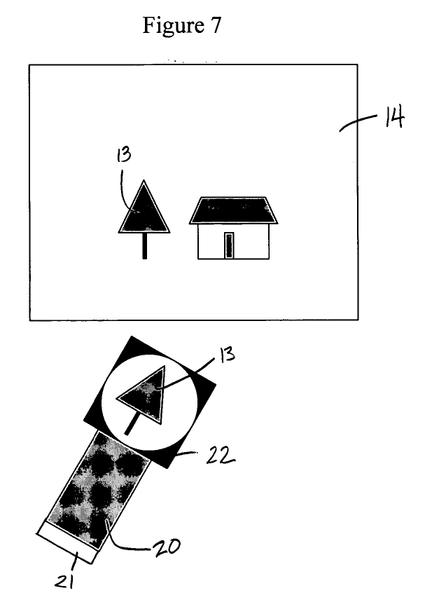

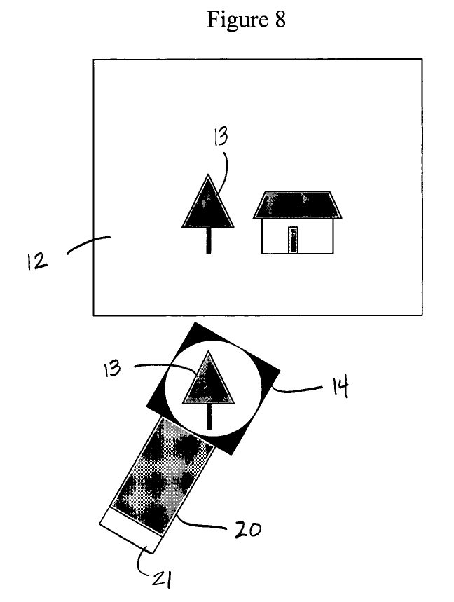

One problem, however, is that when the barrel of the simulated weapon 20 is rotated, the secondary image display 22, which is physically affixed to the simulated weapon 20, should be physically rotated as well. Without detecting and compensating for this effect on the secondary image display 22, there is a visual discrepancy between the primary image display 14 and the secondary image display 22. Specifically, the image transmitted on the secondary image display 22 will remain at the same non-rotated position. Comparing FIG. 6 with FIG. 7, it is clear that the target 13 (illustrated as a tree) remains upright on the primary image display 14 but is angled and aligned with the rotated position of the simulated weapon 20 in the secondary image display 22.

This visual discrepancy of FIG. 7 as compared with FIG. 6 must be corrected in order to improve the verisimilitude of the weapon simulation. In the present invention, one way to correct the image displayed by the secondary image display 22 is to detect the angle of rotation (also referred to as the “cant angle”) of the simulated weapon 20 by attaching a sensor 21 or sensors to or within the simulated weapon 20, such as a cant angle sensor. Using the sensors 21, the image in the secondary display is counter-rotated by the CPU 16 using the software application (with assistance from a 3D graphics card) before rendering it to the secondary image display 22. This then gives the desired visual effect of aligning the perceived image of the secondary image display 22 viewed through the weapon sight 26 with the perceived image on the primary image display 14.

Hardware sensors 21 physically attached to the simulated weapon 20 detect the cant angle of the simulated weapon 20. Using firmware and low-level application program interface (API) code, the signal transmitted by the sensor 21 is used to compensate the image displayed by the secondary image display 22. More specifically, the software application of the CPU 16 creates a temporary display surface upon which it renders a part of the background image, as well as any targets 13 that should appear in the viewing area of the through-sight. This display surface of the secondary image display 22 is then counter-rotated using 3D techniques to texture map the display to a simple quadrangular polygon whose vertices are rotated. The rotation angle is equal and opposite to the cant angle reported by the low level API, and the API is used simply to read the cant angle sensor 21 and pass the value to the software application so that the software application can rotate the image by the same angle

Following the rotation operation, a sight mark overlay is applied which gives the effect of crosshairs, reduces the visually displayed area to a circle (to simulate actual weapon sights 26), and may display other information, such as the Field of View illustrated in FIG. 5.

The initial testing has occurred under simulated conditions with weapon cant simulated by keyboard input to generate weapon cant sensor data packets, with weapon cant simulated to within 0.4 degrees accuracy, and was later verified by testing with a simulated weapon fitted with a cant angle sensor. The image on the secondary image display 22 can be observed to rotate as the simulated cant changes, and the relation between target positioning and the background image is preserved despite rotation and magnification of the image broadcast at the secondary display image 22.

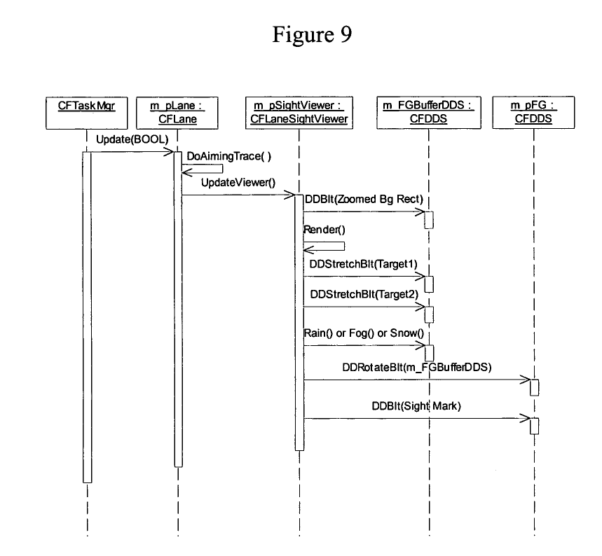

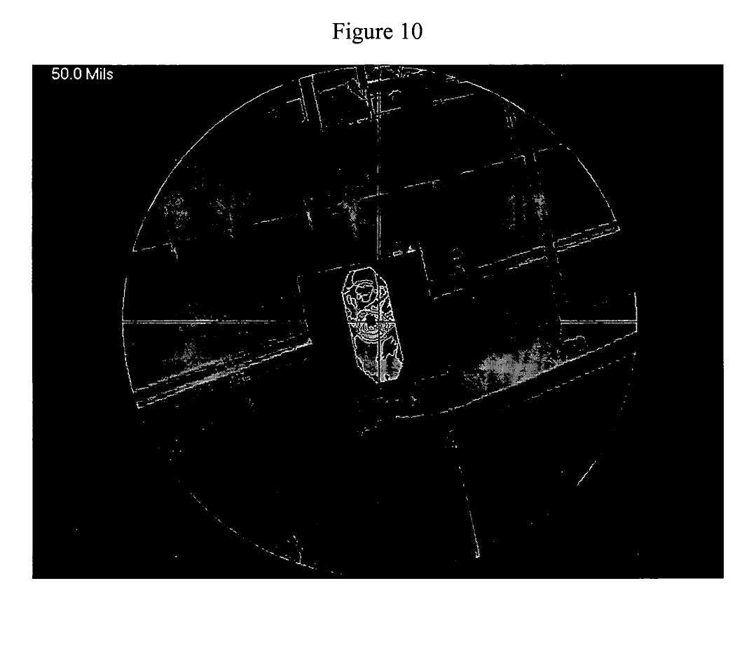

The sequence diagram for the rotated through-sight is shown in FIG. 9. In particular, the process involves the following steps: update the screen image; perform the aim tracing of the laser connected to the simulated weapon; determine the center of the zoomed image based on the position of the laser; capture the zoomed image; scale the image, apply environmental effects, rotate the zoomed image, apply the reticle mask, and render the image on the secondary image display 22, as illustrated in FIG. 10.

While this invention has been described with reference to preferred embodiments thereof, it is to be understood that variations and modifications can be affected within the spirit and scope of the invention as described herein and as described in the appended claims.

1. An optical sight system for using a weapon sight with a simulated weapon assembly having a primary image display providing a simulated image, said system comprising:
a secondary image display providing the sight simulated image; and
an optical lens positioned intermediate said secondary image display and the weapon sight, said optical lens focusing the simulated image on the weapon sight.

2. The optical sight system as described in claim 1, further comprising a central processing unit having an image generator, said image generator creating the simulated image.

3. The optical sight system as described in claim 1, wherein said secondary image display is a microdisplay.

4. The optical sight system as described in claim 1, further comprising a rail supporting said secondary image display and said optical lens.

5. The optical sight system as described in claim 1, wherein said optical lens is a convex lens.

6. The optical sight system as described in claim 1, wherein said optical lens is a varifocal lens.

7. A simulated weapon assembly comprising:
an image generator producing an electronic scenario;
a first image display electrically connected to said image generator, said image generator transmitting said simulated scenario to said first image display;
a simulated weapon;
a weapon sight attached to said simulated weapon;
a second image display electrically connected to said image generator, said image generator transmitting said simulated scenario to said second image display connected to said simulated weapon proximate said weapon sight; and
an optical lens between said second image display and said weapon sight.

8. The simulated weapon assembly as described in claim 7 further comprising:
a rail affixed to said simulated weapon, said rail supporting said second display and said weapon sight.

9. The simulated weapon assembly as described in claim 7 wherein said optical lens comprises a convex lens.

10. The simulated weapon assembly as described in claim 7 wherein said optical lens comprises a varifocal lens.

11. A method for correcting an image displayed in a second image display to correspond with the image displayed in a first image display comprising the steps of:
a) updating the screen image on the second image display;
b) performing the aim tracing of a laser connected to a simulated weapon;
c) determining the center of the zoomed image on the first image display corresponding to the position of the laser;
d) capturing the zoomed image for the secondary image display;
e) scaling the image for the secondary image display;
f) rotating the zoomed image; and
g) rendering the image on the secondary image display.

12. The method as described in claim 11, wherein after step e), comprising the step of:
applying environmental effects.

13. The method as described in claim 11, wherein after step f), comprising the step of:
applying a reticle mask.

14. The method as described in claim 11, wherein after step e), comprising the step of:
transmitting a cant angle signal from a sensor to the CPU.

15. A method for improving the resolution of an image comprising the steps of:
a) determining the coordinates of the image;
b) determining a most recent updated time and a second updated time prior to said most recent updated time;
c) calculating the difference between said most recent updated time and said second most recent updated time;
d) calculating an update time; and
e) choosing between interpolating the coordinates and extrapolating the coordinates according to a comparison of said update time and said difference between said most recent update time and said second most recent updated time.

16. The method as described in claim 15, wherein step e) further comprises the step of:
interpolating the coordinates if said update time is less than or equal to the difference between said most recent update time and said second update time.

17. The method as described in claim 15, wherein step e) further comprises the step of:
extrapolating the coordinate is said update time is greater than the difference between said most recent update time and said second update time.
